(19) United States
(12) Patent Application Publication
(10) Pub. No.: US 2007/0087632 A1
(43) Pub. Date: Apr. 19, 2007

(54) High speed transmission shield cable and method of making the same

(75) Inventors: Jen-Guo Fong, Tu-cheng (TW); Wei Yao, Kunshan (CN); Wen-Fong Su, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/581,814

(22) Filed: Oct. 17, 2006

(30) Foreign Application Priority Data
Oct. 17, 2005 (CN) 200510094922.4

(51) Int. Cl. H01R 9/03

(52) U.S. Cl. 439/610

(57) ABSTRACT

A high speed transmission shield cable (100) includes a pair of wires (13) each including an inner conductor (131) for carrying high frequency signals and an inner insulator (132) surrounding the inner conductor for providing a sheath, at least a grounding conductor (12) disposed adjacent to the wires for providing a grounding property for the high speed transmission shield cable, and an outer jacket (11) surrounding the wires and the grounding conductor. The pair of wires further includes a pair of shielding layers formed of the conductive plastic and surrounding the inner insulator to provide adequate suppression of EMI or RFI interference.

### BACKGROUND OF THE INVENTION

1. Field of the Invention

The present invention is directed to a cable having utility as high frequency transmission lines and having improved shielding properties.

2. Description of Related Arts

It is known that in many applications a conventional coaxial cable, functioned as a transmission media, having multi-conductors surrounded by a single flexible coaxial sheath does not have sufficient shielding properties to provide adequate suppression of EMI or RFI interference. For example, in FIGS. 4 and 5, in a conventional coaxial cable, a pair of internal conductors is respectively covered with a pair of internal insulators formed of dielectric material and twisted with each other for avoiding the capacitance generated between the internal conductors during a signal transmission. The internal insulators are covered with an aluminum foil shielding layer formed by twisting long-strip aluminum foil on the surface of the internal insulators and a metal braid layer twisted on the aluminum foil shielding layer for reducing disturbance caused by an unwanted transfer of energy from external electromagnetic fields and educing excessive charge and crosstalk. However, this conventional coaxial cable has some disadvantages. First, during a process to twist the aluminum foil on the internal insulators, the clearances formed between adjacent aluminum foils make the aluminum foil shielding layer unable to cover the internal insulators completely, and thus provide inadequate suppression of EMI or RFI interference. Second, the pair of conductors is together shielded by a single aluminum foil shielding layer for isolating exterior interference, but provides no shielding for isolating cross talk therebetween. Third, the metal braid layer is formed by metal material for providing a grounding performance. However, the grille-shape clearances of the metal braid layer make electric field distribution uneven, thereby influencing high frequency signal transmission of the coaxial cable.

Hence, a cable having improved shielding properties, providing stable signal transmission, and being easy to manufacture is desired.

### SUMMARY OF THE INVENTION

Accordingly, the object of the present invention is to provide a cable having sufficient shielding properties to meet consumer EMI compatibility requirements.

Another object of the present invention is to provide a high frequency cable having a conductive plastics layer for providing adequate EMI sheath and enough flexibility.

To achieve the above objects, a cable assembly in according with the present invention comprises a pair of wires each including an inner conductor for carrying high frequency signals and an inner insulator surrounding the inner conductor for providing a sheath, at least a grounding conductor disposed adjacent to the wires for providing a grounding property for the high speed transmission shield cable, and an outer jacket surrounding the wires and the grounding conductor. The pair of wires further includes a pair of shielding layers formed of the conductive plastic and surrounding the inner insulator and the grounding conductor to provide adequate suppression of EMI or RFI interference.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a perspective view of a cable in accordance with a first exemplary embodiment of the present invention, with a pair of conductors twisted with each other;

FIG. 2 is a perspective view of a cable in accordance with a second exemplary embodiment of the present invention, with a pair of conductors parallel to each other;

FIG. 3 is a cross-sectional view of the cable shown in FIG. 2;

FIG. 4 is a perspective view of a conventional coaxial cable; and

FIG. 5 is a cross-sectional view of the conventional coaxial cable shown in FIG. 4.

### DETAILED DESCRIPTION OF THE PREFERRED EMBODIMENT

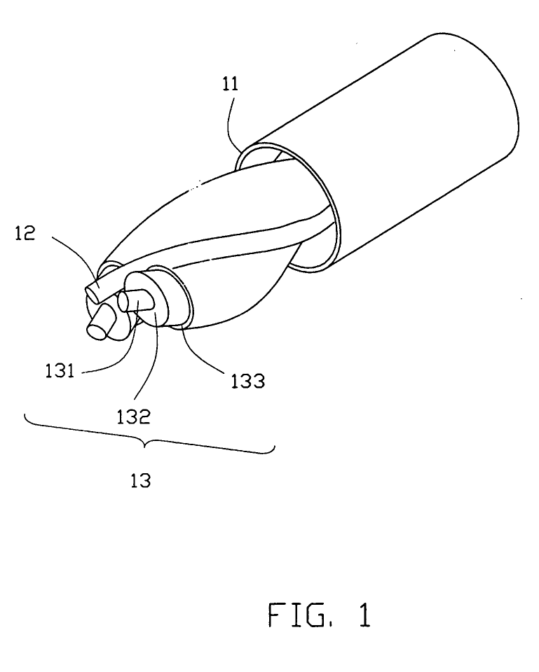

FIG. 1 illustrates a coaxial cable 100 in according with a first exemplary embodiment of the present invention for establishing a high-speed signal transmission between two devices. The cable 100 comprises a pair of wires 13 twisted with each other, a grounding. conductor 12 disposed adjacent to the pair of wires 13, and an outer jacket 11 surrounding the wires 13 and the grounding conductor 12 for providing an sheath for both the wires 13 and the grounding conductor 12. Each wire 13 comprises an inner central conductor 131, an inner insulator 132 enclosing the inner conductor 131, and a shielding layer 133 encasing the inner insulator 132. The inner central conductor 131 is used to transmit high frequency signals. The inner insulator 132 is formed by polytetrafluoroethylene (PTFE) to provide sheath for the inner conductor 131. However, it is to be understood that the inner insulator 132 may be fabricated by other insulative material to meet flexibility and durability requirements in accordance with the principle of the present invention. The shielding layer 133 is designed to provide sufficient suppression of EMI and formed by conductive plastic. In one exemplary embodiment, the shielding layer 133 is a conductive polyester film layer, and encloses the inner insulator 132 in a plastic molding process, especially in an extrusion molding process. During the plastic molding process, the conductive material is added into the melted plastic material equably to form the conductive shielding layer 133. By means of the separated conductive shielding layer 133, the pair of conductors 131 is isolated from each other and respectively shielded against the exterior EMI and cross talk therebetween, thus, the cable 100 has improved flexibility and sufficient shielding properties. In this exemplary embodiment, the pair of shielding layers 133, together with the pair of conductors 131, are twisted with each other to further avoid the leakage of transmission signals and EMI.

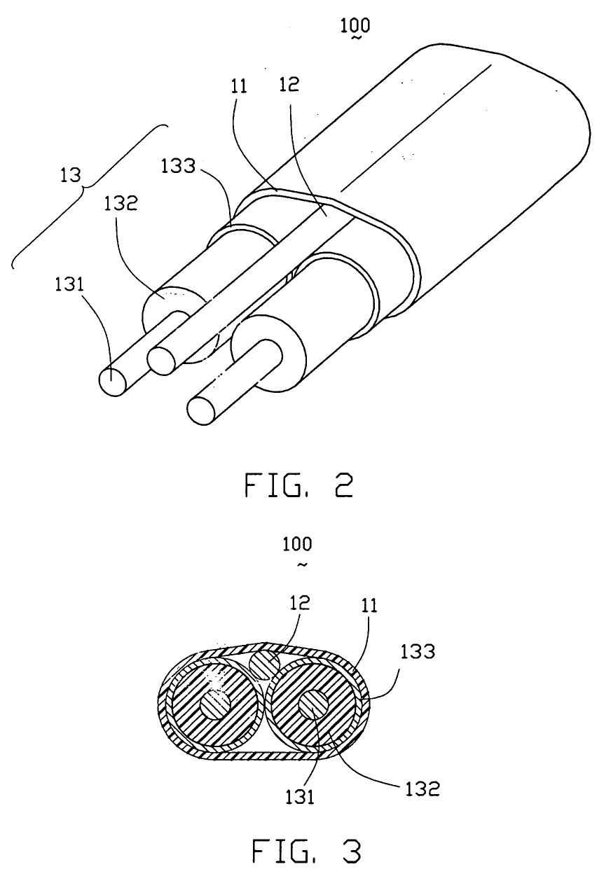

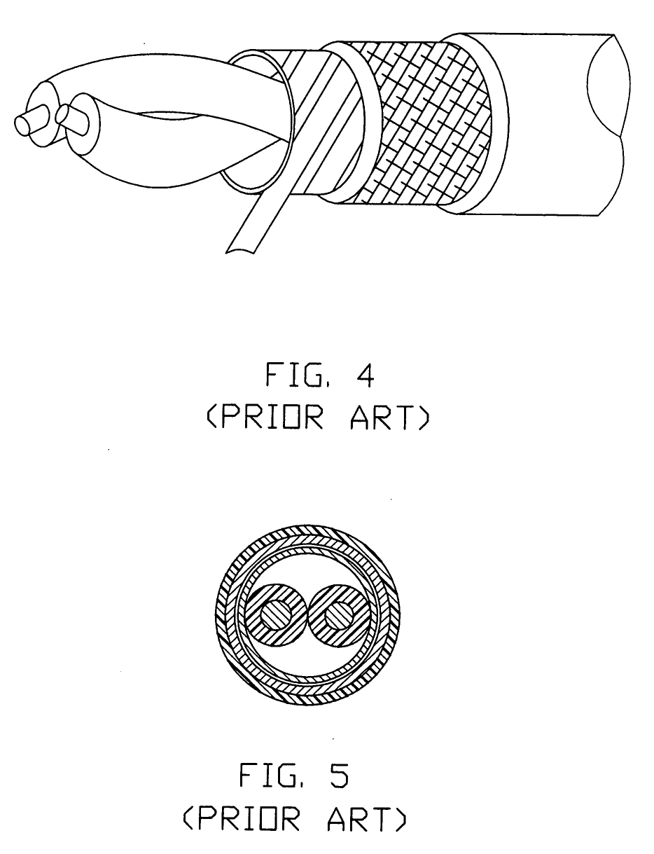

With respect to FIGS. 2-3, is shown second exemplary embodiment of the present invention. Where elements are the same, numbering follows the convention of FIG. 1.

Referring to FIGS. 1-3, the difference between the first and second exemplary embodiments is that the pair of the conductors 131 of the cable 100, together with the pair of shielding layers 133, in second exemplary embodiment is parallel to each other. Thus, compared with the first embodiment, the second embodiment omits a process to twist the pair of conductors 131, and makes the manufacture easy.

In addition, a third exemplary embodiment (not shown) is introduced as below, and is mostly similar to the first and second exemplary embodiments in structure. Further, the third exemplary embodiment has an outer EMI shield that is composed of high coverage metal braid (such as tinned-copper, tinned-nickel) adjacent the conductive shielding layer 133. The metal braid surrounded by the outer jacket 11, is disposed around the outside of the wires 13 and the grounding conductor 12 to achieve a further sheath from EMI.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A high speed transmission shield cable, comprising:
a pair of wires, each wire comprising an inner conductor for carrying highfrequency signals and an inner insulator surrounding the inner conductor for providing a sheath;
at least a grounding conductor disposed adjacent to the wires for providing a grounding property for the high speed transmission shield cable;
and an outer jacket surrounding the wires and the grounding conductor;
wherein each inner insulator of the wire is surrounded by a shielding layer, the shielding layer is formed of the conductive plastic material to provide adequate suppression of EMI or RFI interference.

2. The high speed transmission shield cable as described in claim 1, wherein the pair of wires are parallel to each other.

3. The high speed transmission shield cable as described in claim 1, wherein the pair of wires are twisted with each other.

4. The high speed transmission shield cable as described in claim 1, wherein the outer jacket is formed by insulative material in an extrusion process.

5. The high speed transmission shield cable as described in claim 1, wherein each shielding layer encloses the inner insulator by an extrusion molding process.

6. The high speed transmission shield cable as described in claim 1, further comprising a layer of metal braid surrounding the wires and the ground conductor for providing a further sheath against EMI and/or a grounding performance.

7. A high speed transmission shield cable, comprising:
a conductor for carrying high frequency signals;
an inner insulator surrounding one conductor;
a shielding layer formed by a conductive plastic material and surrounding the inner insulator; and an outer jacket surrounding the shielding layer for proving a sheath.

8. The high speed transmission shield cable as described in claim 7, further comprising a layer of metal braid disposed between the shielding layer and the outer jacket for providing a further suppression of EMI or RFI interference and/or a grounding performance.

9. The high speed transmission shield cable as described in claim 7, further comprising at least a grounding conductor disposed between the shielding layer and the outer jacket for providing a grounding performance.

10. A method of fabricating a coaxial cable comprising:
directing a conductor along a predetermined direction;
extruding a melted thermoplastic polymer precoat composition on the conductors from an extruder;
extruding a conductive plastic material on said melted thermoplastic polymer precoat composition from another extruder;
allowing the layers of thermoplastic precoat composition and the conductive plastic material to cool and solidify to respectively form an inner insulator surrounding the conductor and a shielding layer surrounding the inner insulator for providing a sheath against exterior EMI interference.

11. The method of fabricating the coaxial cable as claimed in claim 10, further comprising a step of providing an outer jacket around the shielding layers.

12. The method of fabricating the coaxial cable as claimed in claim 10, further comprising a step of providing a layer of continued metal braid around the shielding layer for providing adequate suppression of EMI or RFI interference.
